(19) United States
(12) Patent Application Publication
(10) Pub. No.: US 2024/0348127 A1
(43) Pub. Date: Oct. 17, 2024

(54) COOLING ASSEMBLY FOR COOLING A HYBRID VEHICLE OR AN ELECTRICALLY DRIVEN VEHICLE

(71) Applicant: ZF Friedrichshafen AG, Friedrichshafen (DE)

(72) Inventors: Rayk Gersten, Friedrichshafen (DE); Stefan Renner, Bodman-Ludwigshafen (DE); David Wörzler, Langenargen (DE); Stefan Spühler, Friedrichshafen (DE); Martin Christians, Friedrichshafen (DE); Martin Jelinewski, Nonnenhorn (DE); Wolfgang Hübler, Wolpertswende (DE)

(73) Assignee: ZF Friedrichshafen AG, Friedrichshafen (DE)

(21) Appl. No.: 18/682,768

(22) PCT Filed: Aug. 10, 2022
(86) PCT No.: PCT/EP2022/072439

§ 371 Date: Feb. 9, 2024

(30) Foreign Application Priority Data
Aug. 10, 2021 (DE) 10 2021 208 661.6
Aug. 9, 2022 (DE) 10 2022 208 254.0

(51) Int. Cl. H02K 9/19; H02K 7/116; H02K 11/33

(52) U.S. Cl. CPC H02K 9/19; H02K 7/116; H02K 11/33

(57) ABSTRACT

A vehicle cooling arrangement includes a first electric machine with a drive output shaft and a first rotor mounted to rotate about a rotation axis and extending axially around the rotation axis. A first stator surrounds the first rotor peripherally. A second electric machine is mounted axially close to the first electric machine and has a second rotor mounted to rotate about the rotation axis and the drive output shaft. A second stator surrounds the second rotor peripherally. A common housing forms a casing for the first and second electric machines and the drive output shaft extends axially through the housing. The first and second electric machines form a coolant circuit having at least one coolant line arranged to cool the first and second rotors and a second coolant line parallel to the first coolant line and arranged to separately cool the first and second stators.

### RELATED APPLICATIONS

This application claims the benefit under 35 U.S.C. § 371 as a U.S. National Phase application of application no. PCT/EP2022/072439, filed on 10 Aug. 2022, which claims the benefit of German Patent Application no. 10 2021 208 661.6 filed on 10 Aug. 2021 and of German Patent Application no. 10 2022 208 254.0 filed on 9 Aug. 2022, the contents of which are hereby incorporated herein by reference in their entireties.

### FIELD OF THE DISCLOSURE

The invention relates to a cooling arrangement for cooling a hybrid vehicle or an electrically driven vehicle, the cooling arrangement comprising a first electric machine wherein the first electric machine comprises a first rotor mounted to rotate about a rotation axis, wherein the first rotor is arranged coaxially with a drive output shaft, and wherein the rotation axis defines an axial direction, and wherein the first rotor extends in the axial direction around the rotation axis, and the first electric machine additionally comprises a first stator that surrounds the first rotor peripherally, wherein the cooling arrangement comprises a second electric machine mounted axially close to the first electric machine, wherein the second electric machine comprises a second rotor mounted to rotate about the rotation axis, wherein the second rotor is mounted coaxially with the drive output shaft, and wherein the second rotor extends in the axial direction around the rotation axis, and the second electric machine additionally comprises a second stator that surrounds the second rotor peripherally, wherein the cooling arrangement comprises a conjoint housing that forms a casing for the first and second electric machines, wherein the drive output shaft extends through the housing in the axial direction, and wherein the first electric machine and the second electric machine form a first coolant circuit with a first coolant for cooling the first electric machine and the second electric machine. In addition, the invention relates to a cooling arrangement for a vehicle.

### BACKGROUND

During their operation electric machines produce waste heat due to electrical and mechanical losses. This requires the electric machine to be cooled in order to ensure its desired and efficient operation. Overheating of the electric machine can result in damage to the electric machine, for example to the motor bearings or to the stator insulation. Usually, electric machines are accommodated in a housing that encloses the electric machine completely and protects it against contamination, for example by dirt, oil, or fumes. The cooling system is usually arranged inside the housing, or it can be in the form of a water jacket, for example.

The cooling system of an electric motor vehicle, which can be in the form of a hybrid vehicle or a purely electrically powered vehicle, differs substantially from a cooling system in a motor vehicle powered exclusively by means of an internal combustion engine.

DE 10 2019 110 432 A1 discloses an oil cooling system which is arranged so as to enable oil to circulate through an electric machine and an oil-coolant heat exchanger; a cooling system with a line arranged so as to enable coolant to circulate through an inverter, a heating core and the heat exchanger; and a climatisation system arranged so as to enable an airflow to circulate through the heating core in order to heat a passenger compartment with waste heat from the electric machine and the inverter.

DE 10 2015 221 777 A1 discloses a housing arrangement for an electric machine, which comprises a housing with a stator accommodation area, a stator of the electric machine accommodated in the stator accommodation area and a cooling jacket surrounding the stator in order to cool the stator by means of a fluid, wherein the outer wall of the stator at the same time forms the inside surface of the cooling jacket.

### SUMMARY

It is therefore a purpose of the present invention to indicate a better cooling arrangement for cooling a hybrid vehicle or an electrically driven vehicle. Furthermore, another objective is to indicate an improved vehicle cooling arrangement.

These objectives are achieved by a cooling arrangement and a vehicle cooling arrangement as disclosed herein.

The subordinate claims list further advantageous measures that can be suitably combined with one another to achieve further advantages.

The objective is achieved by a cooling arrangement for cooling a hybrid vehicle or an electrically powered vehicle, wherein the cooling arrangement comprises a first electric machine, wherein the first electric machine comprises a first rotor mounted to rotate around a rotation axis, wherein the first rotor is arranged coaxially with the drive output shaft, which can be made at least partially as a hollow shaft, and wherein the rotation axis defines an axial direction and the first rotor extends in the axial direction around the rotation axis, and in addition comprises a first stator that surrounds the first rotor peripherally, and wherein the cooling arrangement also comprises a second electric machine mounted axially close to the first electric machine, and wherein the second electric machine comprises a second rotor mounted to rotate around the rotation axis, the second rotor is mounted coaxially with the drive output shaft and the second rotor extends in the axial direction around the rotation axis, and the second electric machine also comprises a second stator that surround the second rotor peripherally, and the cooling arrangement comprises a conjoint housing which forms a casing for the first and second electric machines, wherein the first electric machine and the second electric machine form a coolant circuit with a first coolant for cooling the first electric machine and the second electric machine, wherein the first coolant circuit comprises at least a first coolant line for cooling the first rotor and the second rotor, and comprises also a second coolant line parallel to the first coolant line for the separate cooling of the first stator and the second stator by means of the second coolant line.

The rotation axis defines an axial direction. A radial direction is then perpendicular to the rotation axis.

By virtue of the invention the first rotor and the second rotor, and also the two stators, are cooled by two separate coolant lines. In that way, for example, a water jacket can be dispensed with and a more compact structure is achieved.

In this case the rotor comprises for example a rotor carrier and the actual rotor itself, for example a packet of laminations.

In particular, the first coolant can be oil, which can also be used for lubrication.

By cooling the rotors and the stators separately, the cooling can be improved. Furthermore, thanks to the parallel cooling, hotspots inside the machines can be prevented and uniform cooling of the rotors and the stators can be achieved.

Thanks to the separate cooling, waste heat can be prevented from getting into the inside of the electric machines from the rotor or the stator. Furthermore, it is possible to prevent subsequent insufficient cooling of the stators, for example, owing to excessive cooling of the rotors and warming up of the coolant. Thereby, greater or more stable power can be achieved. In such cases, more than one and in particular two electric machines can be provided.

In particular, the two electric machines can have the same size, shape, and power.

A further feature is that the first cooling circuit is designed such that after the cooling of the first rotor and the second rotor, the first coolant line can be merged with the second coolant line after the cooling of the first stator and the second stator, to form a conjoint coolant line.

Moreover, the first cooling circuit is configured such that after the conjoint cooling of the coolant in the conjoint coolant line, the conjoint coolant line splits into the first coolant line and the second coolant line.

With such an arrangement simple cooling of the coolant in the first cooling circuit can take place. The coolant, for example oil, can be returned to a fluid reservoir, preferably an oil sump, and passed on again by an oil pump out of the oil sump and into a conjoint coolant line for the conjoint cooling. In that way the coolant in the first cooling circuit can be cooled in a simple manner. Once the coolant has been cooled, the conjoint cooling line is split.

In that way, when the lines are merged coolant losses, particularly when oil is the coolant, can be contained since the oil is also used for lubrication. Thereby, coolant losses from the first or second coolant line take place after the machines have been cooled.

In this case the quantities of the conjoint coolant line can be split up to form a first coolant line and a second coolant line in accordance with the coolant quantities needed for the rotors and stators. Thus, depending on the design of the electric vehicle or hybrid vehicle with two or more electric machines, different coolant amounts can be needed for the rotors and stators. Such differential splitting can be achieved in a simple manner, for example, by means of different cross-sections of the lines through which the coolant flows.

In a further design the first conjoint coolant line is connected to a heat exchanger for cooling the coolant, wherein the heat exchanger is connected to a separate coolant circuit containing a second coolant, so that the first coolant flowing through the conjoint coolant line can be cooled down more by the second coolant.

Thus, the second coolant is used to cool down all of the first coolant, in particular an oil.

In a further version, the drive output shaft has an outside of the drive output shaft that faces toward the two rotors, and in the housing a feed duct that preferably extends radially through the housing and perpendicularly to the drive output shaft is provided, in order to supply a first coolant to the inside space of the housing and to the outside of the drive output shaft, and on the outside of the drive output shaft axially extending ducts are provided, through which at least some of the coolant of the first coolant line is conveyed along the outside of the drive output shaft to the first rotor and to the second rotor. Some of the coolant can be passed axially along the outside of the drive output shaft as far as a differential so that it too can have a cooling and lubricating function.

In another design feature the drive output shaft has an axial bore or is at least partially in the form of a hollow shaft, and coolant from the first coolant line can be passed by way of a feed duct into an inside space of the drive output shaft and axially through the drive output shaft. For this, in the drive output shaft in the circumferential direction there is arranged at least one radially extending through-going opening, for example in the form of a bore leading from the inside space of the drive output shaft to the outside of the drive output shaft to allow the passage of at least some of the coolant in the first line to the outside of the drive output shaft, so that after passing through, an additional fluid flow from the first coolant line can be produced on the outside of the drive output shaft for cooling purposes.

Preferably, when there are several through-going openings in the drive output shaft that extend radially toward the circumference, the through-going openings are distributed equidistantly around the circumference.

In a further design, also arranged in direction toward the circumference there are arranged several through-going openings in the drive output shaft or other components arranged in the housing between the first rotor and the second rotor, so that at least some of the coolant from the first coolant line, after passing through, can be split off along the outside of the drive output shaft and/or through the drive output shaft to the outside thereof, into a first lower coolant path for cooling the first rotor by the lower coolant path, and into a second lower coolant path for cooling the second rotor by the second lower coolant path. This enables uniform cooling of the first and second rotors.

The feed duct through the housing can be in the form of a bore, for example. The flow in the housing along the outside of the drive output shaft and/or through the drive output shaft can take place by virtue of a pump, whereas the passage of at least some of the coolant from the first coolant circuit to the outside of the drive output shaft and to the rotors takes place by virtue of the centrifugal force produced during operation. If the first coolant is oil, then further apertures or through-going openings extending radially toward the circumference direction can be provided for the direct supply of some of the through-flowing oil as a lubricant to particularly wear-prone components such as bearings or gearteeth.

In this context, apertures are gaps or permeable areas provided by design, through which the oil is intended to flow. Through-going openings are openings specially made in components, such as bores or ducts inside or through the contour of a component.

In particular the coolant, specifically the oil in the first coolant line, flows centrally and in the middle through a radially extending aperture or through-going opening, axially between the first rotor and the second rotor, and flows from there over the rotor carrier in order to carry away the heat produced in the two rotors. In that way the two rotors can be cooled by the first coolant line. The first coolant line can thus be split into the first lower coolant path and a second lower coolant path that extends axially in the opposite direction, immediately after its passage through one of the radially extending through-going openings or one of the apertures, in such manner that to cool the first rotor the first lower coolant path extends axially in the direction toward the first rotor and to cool the second rotor the second lower coolant path extends axially in the direction toward the second rotor.

Thereafter, the coolant, specifically the oil, can flow along the front side of the two rotors to a stator underside of the respective stator (again due to centrifugal force) and thus cool the stator concerned from the rotor side.

In a further version, a change-speed transmission is provided, which comprises a first transmission portion having a circuit with one or more shifting elements, and a second transmission portion having at least one gearwheel set, such that the at least one gearwheel set can in particular be formed of a plurality of coupled planetary gearsets and such that the gearwheel set is arranged at least partially within the second (or the first) rotor and the one or more shifting element(s) is/are arranged at least partially within the first (or the second) rotor.

The rotors, which are arranged coaxially with the rotation axis, have an approximately cylindrical inner hollow space in which, preferably, the two transmission portions, planetary gearsets, and the shifting elements, and if need be, at least in part a differential, can be accommodated. This results in a saving of fitting space.

For example, the first or the second electric machine can even be switched on only when necessary. Also preferably, the shifting elements are designed as claw-type shifting elements, such that during any shifting process a traction force interruption takes place. However, thanks to the support provided by the second electric machine powershifts can be carried out.

Furthermore, a planetary gearset comprises at least a sun gear, one or more planetary gearwheels, and a ring gear. The transmission can be a two-gear, a three-gear, or a multi-gear transmission.

In each case a power electronics unit is connected to en electric machine, i.e., to its switching circuit for control purposes.

In a further design version the through-going openings or apertures that extend in the circumferential direction (radially) are arranged between the first rotor and the second rotor in such manner that at least some of the coolant in the first coolant line, after flowing from the outside of the drive output shaft through one or more radially directed through-going openings and/or apertures, is split into a first lower coolant path, this first lower coolant path bypassing the first transmission portion and flowing directly to the first rotor to cool the first rotor by means of the first lower coolant path, and also into a second lower coolant path flowing in the direction opposite to the first lower coolant path, this second lower coolant path flowing to the second rotor to cool the second rotor by means of the second lower coolant path.

In a further design having two transmission portions arranged at least partially inside the rotors, the through-going openings or apertures that extend in the circumferential direction (radially) are arranged between the first rotor and the second rotor in such manner that at least some of the coolant from the first coolant line on the outside of the drive output shaft is split into a first lower coolant path for cooling and lubricating a first transmission portion, in particular the switchgear thereof, whereby after cooling the first transmission portion the first lower coolant path flows to the first rotor to cool it by means of the first lower coolant path, and also into a second lower coolant path flowing in the direction opposite to the first lower coolant path, for cooling the second rotor, wherein the coolant bypasses the second transmission portion, in particular the gearsets, so as to flow to the second rotor by means of the second lower coolant path while bypassing the second transmission portion, in order to avoid any transfer of heat from the transmission into the electric machines, in particular their rotors.

In this case the flow of coolant from the second lower coolant path to the second rotor, as also the flow of coolant from the first lower coolant path to the first rotor, take place essentially due to centrifugal force. In this case the first transmission portion can even be arranged at least partially inside the second electric machine and the second transmission portion can even be arranged at least partially inside the first electric machine.

Moreover, the coolant can be an oil and the drive output shaft comprises one or more radial through-going openings for the passage of some of the oil, so enabling a direct lubrication of the various bearings and/or other structural elements in the two electric machines.

This ensures efficient cooling of the two rotors and the transmission by the first coolant line and the lubrication of individual components, such as relevant wear-prone elements.

In a further design version, the first stator has at its respective axial ends first winding heads, and the second stator has at its respective axial ends second winding heads, so that after cooling the first rotor, due to the centrifugal force produced by rotation, the first lower coolant path flows to the first winding heads so that the first winding heads of the first stator are cooled, and after cooling the second rotor, due to the centrifugal force produced by rotation the second lower coolant path flows to the second winding heads so that the second winding heads of the second stator are cooled.

In that way the first coolant line is used completely for cooling individual components, such as bearings, the first and second rotors and the winding heads of the stators. Then the coolant, here for example oil, is returned to an oil sump and collected therein, and pumped out of the oil sump as a conjoint coolant line.

In a further design, the first stator has a first stator upper side facing toward the housing and the second stator has a second stator upper side facing toward the housing, wherein the first stator upper side has a plurality of first stator ducts extending parallel to the rotation axis and distributed over an axial length of the first stator and around the circumference of the first stator. In this case the first stator ducts can each have radially through-going first inlet openings in the first stator upper side. In addition, preferably, the second stator upper side has a plurality of second stator ducts extending parallel to the rotation axis and distributed over an axial length of the second stator and around the circumference of the second stator, wherein the second stator ducts can each have radially through-going second inlet openings in the second stator upper side. Furthermore, at least one distributor duct can be provided for feeding coolant in from the first coolant circuit as a second coolant line. The distributor duct is located in the housing and extends through the housing both to the first inlet openings and to the second inlet openings in order to distribute the coolant of the second coolant line to the first inlet openings as a first upper coolant path and to the second inlet openings as a second upper coolant path.

The coolant of the second coolant line is thus conveyed to the housing that surrounds the stators and from there, via a distributor duct in the housing, to the first and second stators. The coolant, preferably oil, flows into the first and second stator ducts and absorbs waste heat from the stators, so cooling them.

In that way, by virtue of the second coolant line a first upper coolant path and a second upper coolant path are formed, which cool the outside of the first and second stators.

In a further design the first inlet openings are arranged in the first stator upper side and the second inlet openings are arranged in the second stator upper side in such manner that the coolant flows equally distributed into the first and second stator ducts.

By virtue of the two coolant lines, which are parallel, and which cool the rotors and the stators independently of one another, the cooling efficiency can be improved.

Preferably the first stator has a number of first grooves and first webs, the number of first stator ducts being equal to the number of first webs, and the second stator has a number of second grooves and second webs, the number of second stator ducts being equal to the number of second webs. This results in targeted and effective cooling of the stators.

In a further version the first stator has at its respective axial ends first winding heads, and the first stator ducts in the first stator upper side each extend to the first winding heads and are open toward the first winding heads, so that after the first coolant has flowed through the first stator ducts the first coolant can flow out onto the first winding heads, whereas the first stator has at its respective axial ends first winding heads, and the first stator ducts in the first stator upper side each extend to the first winding heads and are open toward the first winding heads, so that after the first coolant has flowed through the first stator ducts the first coolant can flow out onto the first winding heads, and the second stator has at its respective axial ends second winding heads, and the second stator ducts in the second stator upper side each extend to the second winding heads and are open toward the second winding heads, so that after the first coolant has flowed through the first stator ducts the first coolant can flow out onto the first winding heads, whereas the first stator has at its respective axial ends first winding heads, and the first stator ducts in the first stator upper side each extend to the first winding heads and are open toward the first winding heads, so that after the first coolant has flowed through the second stator ducts the first coolant can flow out onto the second winding heads.

This makes it possible to cool the stators all round their circumference. After the oil has cooled the winding heads it flows, for example, back into the oil sump and from there, as a conjoint coolant line, is brought into connection with the second coolant circuit via the heat exchanger for cooling purposes. This enables effective cooling of the heated oil.

In another design, the first and second stator ducts have a surface-enlarging cross-section shape, which enables better heat transfer. The shape can for example be a floret shape, a star shape, or some other rotationally symmetrical shape. In that way the heat extraction from the stator concerned can be increased.

Moreover, a third coolant line can be provided, which is split off from the conjoint coolant line or from the first coolant line or the second coolant line. This can be supplied, via a through-going opening in the housing and/or in a component fixed to the housing, and if necessary further apertures and through-going openings, to the second transmission portion, the gearwheel set, in order to cool it separately. Thereafter, the coolant in the third coolant line can be collected in the oil sump and fed back into the conjoint coolant line.

This enables efficient cooling of the transmission and the two rotors while keeping the space occupied as small as possible.

In addition, the objective is achieved by a vehicle cooling assembly having a cooling arrangement as described above, this vehicle cooling arrangement comprising a separate second coolant circuit containing a second coolant, wherein in the second coolant circuit at least two power electronics units are arranged which can be cooled by the coolant of the second coolant circuit, the two power electronic units being designed to drive the first electric machine and the second electric machine. The second coolant circuit also contains a heat exchanger which is arranged in the second coolant circuit after the at least two power electronic units, so that the at least two power electronic units are cooled first.

In this case the first power electronic unit drives the first electric machine and the second power electronic unit drives the second electric machine.

Thanks to the prioritized cooling of the power electronics units the sensitive electronic elements such as the inverter are cooled first, i.e., cooled more intensely than if the coolant first flows through the heat exchanger. In that way the highly sensitive electronic units can be protected against damage due to too high a temperature. As the second coolant, a refrigerant such as a water-glycol mixture, a synthetic cooling fluid, but also air can be used.

Thus, only after the cooling of the power electronics units is the second coolant used to cool down the first coolant, in particular an oil. Thanks to this arrangement efficient cooling can be achieved, which cools the highly sensitive power electronics units first as a priority. In the second coolant circuit, sequentially one after another after the heat exchanger a heater, a consumer and a cooler can also be arranged. Likewise, a water pump can also be present in order to bring about convection in the second circuit.

### BRIEF DESCRIPTION OF THE DRAWINGS

Further properties and advantages of the present invention emerge from the following description, which refers to the attached figures that show, schematically in each case:

FIG. 1: A cooling arrangement according to the invention,

FIG. 2: A vehicle arrangement according to the invention, with a heat exchanger,

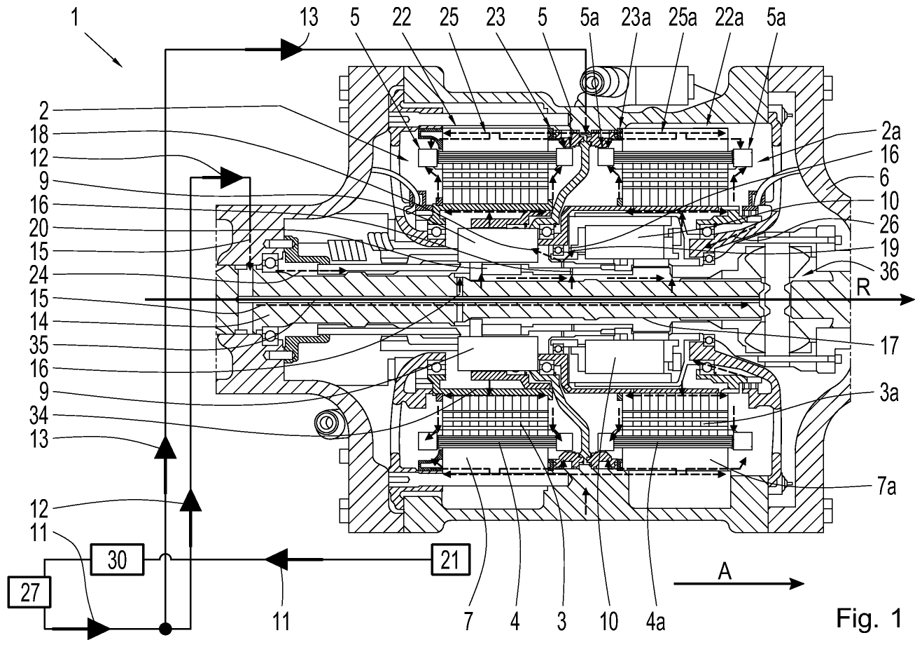

FIG. 1 shows a cooling arrangement according to the invention.

### DETAILED DESCRIPTION

The cooling arrangement 1 according to the invention comprises a first electric machine 2. The first electric machine 2 comprises a first rotor 3 and a first stator 4. The first rotor 3 is mounted to rotate coaxially about a rotor axis R, which defines an axial direction A. In addition, the stator 4 is mounted coaxially with the first rotor 3.

The first stator 4 has at its respective axial ends (front ends) a first winding head 5. The first rotor 3 is preferably formed as a lamination packet on a rotor carrier 34.

In addition, a second electric machine 2a arranged parallel to the first electric machine 2 is provided. This also comprises a second rotor 3a which is mounted to rotate coaxially about the rotor axis R, and a stator 4a. The first rotor 3 and the second rotor 3a are each connected rotationally fixed to a rotor carrier 34.

The second stator 4a has at each of its respective ends (at its two front ends) a second winding head 5a.

The first machine 2 and the second machine 2a are accommodated together in a housing 6. In this case the housing 6 can consist of one or more parts and in particular is in the form of a housing ring with housing covers that can be fixed onto the two sides.

Furthermore, the first stator 4 comprises a first stator lamination packet 7 (also called the stator back), which faces away from the first rotor 3, i.e., toward the housing 6.

Moreover, the second stator 4a comprises a second stator lamination packet 7a (also called the stator back), which faces away from the second rotor 3a, i.e., toward the housing 6.

In this case the first and second stator lamination packets 7, 7a can be attached to the housing 6.

In addition, the cooling arrangement 1 comprises a drive output shaft 14, this drive output shaft 14 extends through the housing 6 in an axial direction A and is partially in the form of a hollow shaft through which a cooling bore 35 extends axially and centrally. The drive output shaft 14 has a drive output shaft outside 17 that faces toward the first and second rotors 3, 3a.

Furthermore, the cooling arrangement 1 comprises a change-speed transmission with a first transmission portion 9 and a shifting system. The shifting system comprises one or more shifting elements. Moreover, the shifting elements can be in the form of claw-type shifting elements.

In addition, the cooling arrangement 1 comprises a second transmission portion 10 which has at least one gearwheel set, wherein this second transmission portion 10 can in particular be formed of several planetary gearsets.

The rotors 2, 2, which are arranged coaxially with the rotation axis R, have an approximately cylindrical inside hollow space within which, preferably, the first transmission portion 9, i.e., the shifting system with its shifting elements, and the second transmission portion 10, with the gearwheel set and, if necessary, also an axle differential 35, can be accommodated. This results in a saving of fitting space.

The cooling arrangement 1 has a first coolant circuit with oil as a first coolant.

The first coolant circuit has a conjoint coolant line 11, which splits into at least two coolant lines, namely a first coolant line 12 and a second coolant line 13.

The first coolant line 12 flows through a feed duct 15 that extends radially through the housing 6 to the drive output shaft 14, in order to convey the oil onto and into the drive output shaft 14. For that purpose, the drive output shaft 14 is made at least partially as a hollow shaft. This is realized by a centrally extending cooling bore 35.

The feed duct 15 is located at an end of the housing 6 so that an easy supply is possible and whereby the oil flows along the outside 17 of the drive output shaft 14 and through the drive output shaft 14, so enabling efficient cooling of the first rotor 3 and the second rotor 3a from the drive output shaft 14.

In the drive output shaft 14 radial through-going openings 16 are arranged, which extend from the cooling bore 35 to an outside 17 of the drive output shaft in order to convey at least some of the coolant in the first coolant line 12 to the outside 17 of the drive output shaft.

In addition, further axially extending apertures 24 are provided in order to convey some of the oil onto the outside 17 of the drive output shaft, so that it can flow along the outside 17 of the drive output shaft to radially extending through-going openings 16 and as far as the axle differential 36.

In this case through-going openings 16 are provided essentially between the first transmission portion 9 and the second transmission portion 10. The passage through the through-going openings 16 takes place essentially due to the action of centrifugal force.

The first coolant line 12 flows at least in part through a central through-going opening 16 and is split into a first lower coolant path 18 in the direction toward the first rotor and a second lower coolant path 19 flowing in the opposite direction.

Furthermore, further radially extending through-going openings 16 can be provided for the passage of some of the oil out of the drive output shaft 14 onto the outside of the drive output shaft, so enabling direct lubrication of bearings and/or other structural elements in the first electric machine 2 and/or the second electric machine 2a. Such a bearing is, for example, a needle bearing 20.

After cooling the first transmission portion 9 and shifting elements, the first lower coolant path 18 flows—preferably by virtue of centrifugal force—toward the first rotor 3 to cool it by means of the first lower coolant path 18. There, the oil flows along the front of the rotor and thereby cools the first rotor 3. In this case some of the coolant from the first lower coolant path 18 can bypass the first transmission portion 9 and flow directly to the first rotor 3.

Preferably, owing to the centrifugal force produced, the second lower coolant path 19 flows to the second rotor 3a to cool it. There, the oil flows along the front of the rotor and thereby cools the second rotor 3a.

After cooling the first rotor 3 the oil from the first lower path 18 flows away onto the first winding head 5 of the first stator 4 in order to cool it. After cooling the second rotor 3a, the oil from the second lower coolant path 19 flows away onto the second winding head 5a of the second stator 4a to cool it.

Moreover, the oil is used again to cool the rotors 3, 3a and the winding heads 5, 5a. The through-flowing oil of the first coolant line 12 is also used to lubricate the first transmission portion 9 and/or also, for example, any bearings present such as the needle bearing 20. For this, additional, separate through-going openings in the form of bores in the drive output shaft 14 are provided, in order to supply oil from the drive output shaft 14 to the bearings or structural components in a targeted manner. In this case the flow is brought about mainly by the centrifugal force produced during operation, so that in essence no oil pump is needed at those points.

After the winding heads 5, 5a have been cooled, the remaining oil is collected in an oil sump 21.

The second coolant line 13 is used for cooling the two stators 4, 4a.

For that, the first stator 4 has in the first stator lamination packet 7 a stator upper side 22 on a side facing toward the housing 6, and the second stator 4a has in the second stator lamination packet 7a a second stator upper side 22a on a side facing toward the housing 6.

Moreover, extending over the axial length of the first stator 4 and parallel to the rotor axis R first stator ducts are provided in the first stator 4, which have first inlet openings 23 and outlets at the respective ends directed toward the first winding heads 5. In addition, extending over the axial length of the second stator 4a and parallel to the rotor axis R second stator ducts are provided in the second stator 4a, which have second inlet openings 23a and outlets at the respective ends directed toward the second winding heads 5a.

In this case the first and second stator ducts, respectively, are distributed almost equidistantly around the circumference of the stator 4, 4a concerned. In particular the number of first stator ducts is equal to the number of first webs and first grooves on the first stator 4, and the number of second stator ducts is equal to the number of second webs and second grooves on the second stator 4a Thereby, good and sufficient cooling can be achieved.

Furthermore at least one distributor duct (not shown) is provided, which conveys the oil from the second coolant line 13 through the housing 6 to the first inlet openings 23 as the first upper coolant path 25 and to the second inlet openings 23a as the second upper coolant path 25a. From there, the oil flows into the first inlet openings 23 and into the second inlet openings 23a.

Through the first stator ducts the oil then flows to the respective axial one-sided outlet openings and from there onto the two first winding heads 5, in order to cool them. The oil then flows back into the oil sump 21.

Through the second stator ducts the oil then flows to the respective axial one-sided outlet openings and from there onto the two second winding heads 5a, in order to cool them. The oil then flows back into the oil sump 21.

Furthermore, a third coolant line 26 is provided, which is split off from the conjoint coolant line 11 or from the first coolant line 12 or the second coolant line 13. This coolant can be delivered directly to the second transmission portion 10, to the gearwheel set, in order to cool it separately. For that purpose, through-going openings or special coolant ducts can be provided in or on the housing 6 or components fixed thereto, through which the coolant is conveyed axially to the second transmission portion 10. Then, the third coolant line 26 can again be collected in the oil sump 21.

This enables efficient cooling of the transmission and the two rotors, while keeping the structural space occupied as small as possible.

The coolant in the conjoint coolant line 11 drawn out from the oil sump 21 is cooled by means of a heat exchanger 27 and a second coolant circuit.

The oil collected in the oil sump 21 is drawn off as the conjoint coolant line 11 by means of an oil pump 30, to be cooled by a heat exchanger 27 with the help of a second coolant circuit.

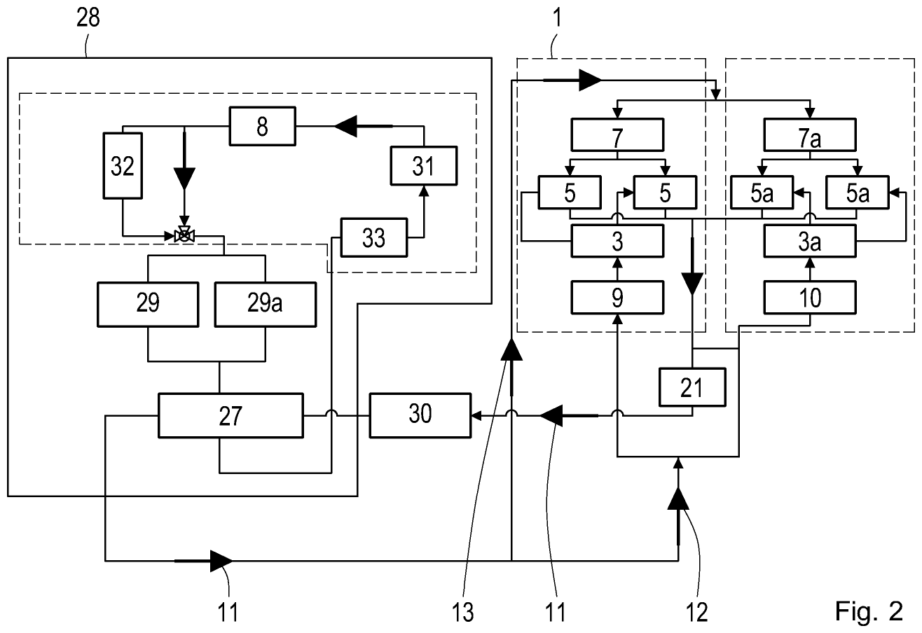

FIG. 2 shows a vehicle arrangement 28 with a heat exchanger 27 and a second coolant circuit.

This second coolant circuit has as its coolant, for example a water-glycol mixture or some other synthetic cooling fluid.

Furthermore, the second coolant circuit has two power electronics units 29, 29a for controlling the two electric machines 2, 2a. For that purpose, the two power electronic units 29, 29a each comprise an inverter.

Moreover, the second coolant circuit can also have, in succession, a heater 33, a consumer 31 and at least one vehicle cooler 32, as well as a water pump for circulating the coolant in the second coolant circuit.

In this case, in the second coolant circuit the heat exchanger 27 is arranged after the at least two power electronics units 29, 29a so that the two power electronics units 29, 29a are cooled first by the coolant.

In that way, after cooling the two power electronics units 29, 29a the coolant flows to the heat exchanger 27 where it merges into the coolant line 11. The latter is drawn from the oil sump 21 by an oil pump 30 and delivered to the heat exchanger 27 and cooled down a by the heat exchanger 27. Thereafter, once the coolant line 11 has been cooled down it is split into the at least one first coolant line 12 and the at least one second coolant line 13 in order to cool the first electric machine 2 and the second electric machine 2a.

### INDEXES

1 Cooling arrangement
2 First electric machine
2a Second electric machine
3 First rotor
3a Second rotor
4 First stator
4a Second stator
5 First winding head
5a Second winding head
6 Housing
7 First stator lamination packet
7a Second stator lamination packet
8 Water pump
9 First transmission portion
10 Second transmission portion
11 Conjoint coolant line
12 First coolant line
13 Second coolant line
14 Drive output shaft
15 Feed duct
16 Through-going openings
17 Outside of the drive output shaft
18 First lower coolant path
19 Second lower coolant path
20 Needle bearing
21 Oil sump
22 First stator upper side
22a Second stator upper side
23 First inlet openings
23a Second inlet openings
24 Apertures
25 First upper coolant path
25a Second upper coolant path
26 Third coolant line
27 Heat exchanger
28 Vehicle arrangement
29 First power electronics unit
29a Second power electronics unit
30 Oil pump
31 Consumer
32 Vehicle cooler
33 Heater
34 Rotor carrier
35 Cooling bore
36 Axle differential
R Rotor axis
A Axial direction

1. A cooling arrangement (1) for cooling a hybrid vehicle or an electrically powered vehicle, the cooling arrangement (1) comprising:
a first electric machine (2), wherein the first electric machine (2) comprises a first rotor (3) mounted to rotate about a rotation axis (R) and a drive output shaft (14), wherein the first rotor (3) is arranged coaxially with the drive output shaft (14), and wherein the rotation axis (R) defines an axial direction (A), and wherein the first rotor (3) extends in the axial direction (A) about the rotation axis (R), the first electric machine further comprising a first stator (4) that surrounds the first rotor (3) peripherally;
a second electric machine (2a) mounted axially close to the first electric machine (2), wherein the second electric machine (2a) comprises a second rotor (3a) mounted to rotate about the rotation axis (R), wherein the second rotor (3a) is mounted coaxially with the drive output shaft (14) and wherein the second rotor (3a) extends in the axial direction (A) about the rotation axis (R), the second electric machine further comprising a second stator (4a) that surrounds the second rotor (3a) peripherally;
a first coolant circuit having at least one first coolant line (12) configured for cooling the first rotor (3) and the second rotor (3a) and a second coolant line (13) parallel to the first coolant line (12), the second coolant line configured for the separate cooling of the first stator (4) and the second stator (4a) by means of the second coolant line (13);
wherein the second electric machine (2a) has a conjoint housing (6) which forms a casing for the first electric machine (2) and the second electric machine (2a);
wherein the drive output shaft (14) extends through the housing (6) in the axial direction (A), and wherein the first electric machine (2) and the second electric machine (2a) are arranged in the first coolant circuit which contains a first coolant for cooling the first electric machine (2) and the second electric machine (2a).

2. The cooling arrangement (1) according to claim 1, wherein the first coolant circuit is configured such that after the cooling of the first rotor (3) and the second rotor (3a) the first coolant line (12) merges with the second coolant line (13) after the cooling of the first stator (4) and the second stator (4a), to form a conjoint coolant line.

3. The cooling arrangement (1) according to claim 2, wherein the first coolant circuit is is configured such that after the combined cooling by the conjoint coolant line (11), the conjoint coolant line (11) is split into the first coolant line (12) and the second coolant line (13).

4. The cooling arrangement (1) according to claim 3, wherein the first conjoint coolant line (11) is connected to a heat exchanger (27) for cooling, while the heat exchanger (27) is connected to a separate, second circuit containing a second coolant for cooling down the first coolant flowing through the conjoint coolant line (11) by means of the second coolant.

5. The cooling arrangement (1) according to claim 1, wherein the drive output shaft (14) has an outer drive output shaft side (17) that faces toward the two rotors (3, 3a), and in the housing (6) has a feed duct (15) extending radially through the housing (6) to the drive output shaft (14), the feed duct configured for supplying coolant onto and into the drive output shaft (14) as the first coolant line (12).

6. The cooling arrangement (1) according to claim 1, wherein at least one through-going opening (16) that extends radially in the circumferential direction toward the outside (17) of the drive output shaft is provided in the drive output shaft (14), the at least one through-going opening configured for conveying at least some of the coolant in the first coolant line (12) to the outside (17) of the drive output shaft, so that after passing through, a fluid flow of the first coolant line (12) onto the outside (17) of the drive output shaft takes place.

7. The cooling arrangement (1) according to claim 1, comprising:
a plurality of through-going openings (16) and/or apertures (24) extending toward the circumference and arranged between the first rotor (3) and the second rotor (3a), so that at least some of the coolant of the first coolant line (12), after being conveyed to the drive input shaft (14) and to the outside (17) thereof, and after flowing through the plurality of through-going openings (16) and/or apertures (24) extending toward the circumference between the first rotor (3) and the second rotor (3a), the first coolant line (12) can be split up into a first lower coolant path (18) for the cooling of the first rotor (3) by the first lower coolant path (18), and into a second coolant path (19) that flows in the direction opposite to the first coolant path (18) for the cooling of the second rotor (3a) by the second lower coolant path (19).

8. The cooling arrangement (1) according to claim 1, comprising a change-speed transmission comprising a first transmission portion (9) with one or more shifting elements and a second transmission portion (10) with at least one gearwheel set, wherein the second transmission portion (10) is at least partially arranged inside the second rotor (3a) and the first transmission portion (9) is arranged at least partially inside the first rotor (3).

9. The cooling arrangement (1) according to claim 8, wherein the through-going openings (16) that extend in the circumferential direction are located between the first rotor (3) and the second rotor (3a), so that at least some of the coolant of the first coolant line (12) is split off from the outside (17) of the drive output shaft into a first lower coolant path (18) for cooling the first transmission portion (9), wherein after cooling the first transmission portion (9) the first lower coolant path (18) flows to the first rotor (3) for the cooling of the first rotor (3) by the first lower coolant path (18), and in addition into a second lower coolant path (19) that flows in the direction opposite to the first lower coolant path (18) for the cooling of the second rotor (3a) by the second lower coolant path (19).

10. The cooling arrangement (1) according to claim 8, wherein the first stator (4) has first winding heads (5) at each of its ends and the second stator (5a) has second winding heads at each of its ends, so that the first lower coolant path (18), after cooling the first rotor (3), flows under the action of the centrifugal force produced by the rotation to the first winding heads (5), thereby cooling the first winding heads (5) of the first stator (4), and the second lower coolant path (19), after cooling the second rotor (3a), flows under the action of the centrifugal force to the second winding heads (5a), thereby cooling the second winding heads (5a) of the second stator (4a).

11. The cooling arrangement (1) according to claim 1, wherein the coolant is an oil and the drive output shaft (14) has one or more radial apertures (24) arranged to let through some of the oil, so that the various bearings and/or other structural elements located in the first electric machine (2) and/or in the second electric machine (2a) can be lubricated.

12. The cooling arrangement (1) according to claim 1, wherein the first stator (4) has a first stator upper side (22) facing toward the housing (6) and the second stator (4a) has a second stator upper side (22a) facing toward the housing (6), wherein the first stator upper side (22) has a plurality of first stator ducts which extend parallel to the rotor axis (R) and are distributed over an axial length of the first stator (4) and around the circumference of the stator, and the first stator ducts each have radially through-going first inlet openings (23) in the first stator upper side (22), and the second stator upper side (22a) has a plurality of second stator ducts which extend parallel to the rotor axis (R) and are distributed over an axial length of the second stator (4a) and around the circumference of the stator, and the second stator ducts each have radially through-going second inlet openings (23a) in the second stator upper side (22a), and in addition at least one distributor duct is provided for conveying coolant from the first coolant circuit as a second coolant line (13), wherein the distributor duct is arranged in the housing (6) and extends both to the first inlet openings (23) and to the second inlet openings (23a), in order to distribute coolant from the second coolant line (13) to the first inlet openings (23) as a first upper coolant path (25) and to the second inlet openings (23a) as a second coolant path (25a).

13. The cooling arrangement (1) according to claim 12, wherein the first stator (4) has a plurality of first grooves and first webs, the number of first grooves being equal to the number of first webs, and the second stator (4a) has a plurality of second grooves and second webs, the number of second grooves being equal to the number of second webs.

14. The cooling arrangement (1) according to claim 12, wherein the first stator (4) has at each axial end first winding heads (5) and the first stator ducts in the first stator upper side (22) extend in each case as far as the first winding heads (5) and are open toward the first winding heads (5), so that after the coolant has flowed through the first stator ducts the first coolant can flow out onto the first winding heads (5), and wherein the second stator (4a) has at each axial end second winding heads (5a) and the second stator ducts in the second stator upper side (22a) extend in each case as far as the second winding heads (5a) and are open toward the second winding heads (5s), so that after the first coolant has flowed through the second stator ducts the first coolant can flow out onto the second winding heads (5a).

15. The cooling arrangement (1) according to claim 12, wherein the first stator ducts and the second stator ducts have a surface-enlarging cross-section shape, so enabling faster dissipation of heat.

16. The cooling arrangement (1) according to claim 1, comprising a third coolant line (26) split off from the conjoint coolant line (11) or from the first coolant line (12) or the second coolant line (13).

17. The cooling arrangement (1) according to claim 16, wherein coolant is configured to be delivered via the third coolant line (26) by way of a through-going opening (16) in the housing and/or in a component fixed to the housing, and if necessary by way of further apertures (24) and through-going openings (16) to the second transmission portion (10), in order to cool the second transmission portion (10) separately.

18. The cooling arrangement (1) according to claim 16, wherein after a cooling process, coolant from the third coolant line (26) is fed back again into the conjoint coolant line (11).

19. A vehicle cooling assembly with a cooling arrangement (1) according to claim 1, the cooling assembly comprising:
a separate second coolant circuit having a second coolant, wherein in the second coolant circuit at least two power electronics units (29, 29a) are arranged, wherein the two power electronics units (29, 29a) are configured to drive the first electric machine (2) and the second electric machine (2a) respectively; and
a heat exchanger (27) arranged in the second coolant circuit after the at least two power electronics units (29, 29a) so that the at least two power electronics units (29, 29a) are cooled first.
